(19) United States
(12) Patent Application Publication
(10) Pub. No.: US 2016/0188588 A1
(43) Pub. Date: Jun. 30, 2016

(54) GIGA MEDIA SERVICE APPARATUS AND METHOD

(71) Applicant: ELECTRONICS AND TELECOMMUNICATIONS RESEARCH INSTITUTE, Daejeon (KR)

(72) Inventor: Hyun-Woo OH, Daejeon (KR)

(21) Appl. No.: 14/984,129

(22) Filed: Dec. 30, 2015

(30) Foreign Application Priority Data
Dec. 30, 2014 (KR) 10-2014-0193922

(51) Int. Cl. G06F 17/30; G06F 3/0482; G06F 3/0484; H04L 29/06

(52) U.S. Cl. CPC G06F 17/30029; H04L 65/40; G06F 17/3005; G06F 3/0482; G06F 3/04842

(57) ABSTRACT

A Giga media service apparatus and method is provided. The method includes receiving a service keyword and a user condition, searching for a component that is relevant to the service keyword and the user condition, searching for a resource needed to operate the searched for component, analyzing whether the searched for component and the searched for resource are usable according to the user condition, when the searched for component and the searched for resource are usable, mapping the searched for component and the searched for resource, inducing a usable service having a relationship with the mapped component and resource, and mapping the usable service to the mapped component and resource, and providing the mapped service and component to a user.

### CROSS-REFERENCE TO RELATED APPLICATION

This application claims priority to and the benefit of Korean Patent Application No. 2014-0193922, filed on Dec. 30, 2014, the disclosure of which is incorporated herein by reference in its entirety.

### BACKGROUND

1. Field of the Invention

The present invention relates to a Giga media service apparatus and method.

2. Discussion of Related Art

Conventional media service technology implements a service component dependent on a service, and executes the service by implementing a common component for operating service components. That is, one service component may be generated in order to provide one service, and the common component is used in that one service.

A conventional patent relates to a method of operating a theme screen configured as a component in a financial automation device, and a financial automation device and system supporting the same. After a host generates component configuration information for a theme change using customer information, position information of the financial automation device, business branch information of the financial automation device, and the like, a theme change command is lowered simultaneously with the component configuration information being transmitted to the corresponding financial automation device. The financial automation device receiving the component configuration information configures a component according to the component configuration information, and updates a current theme screen, but updates only a component which is not duplicated among the entire screen. Accordingly, advertisements, errors, and notification message screens are diversely provided to the financial automation device according to a theme, since the common configuration element in the theme screen is implemented as a component, resource requirements of the device are significantly reduced, and duplicate efforts are avoided when configuring the screen.

Further, since the related art follows a service-oriented component model and has a builder generating a service and a mechanism configuring the service exist, the related art provides the service by connecting a component to a corresponding service through the builder.

However, conventional media service technology has a limitation in that only a service that is predetermined can be provided since a user who desires to provide a service cannot know that any component and any service is provided in any relationship.

Accordingly, when a service provider desires to generate and provide an arbitrary service, a method of finding and connecting usable components using a user input, and providing a new service is required.

### PRIOR ART DOCUMENT

### Patent Document

(Patent document 1) Korean Patent Publication No. 10-2006-0060767A

### SUMMARY OF THE INVENTION

The present invention is directed to a Giga media service apparatus and method capable of automatically configuring a component and a resource and registering and providing a new service since a provider or a user of a service searches for the component and the resource for a service using a keyword and a condition and selects by a relationship.

According to one aspect of the present invention, there is provided a Giga media service method performed by a Giga media service apparatus.

The Giga media service method includes receiving a service keyword and a user condition; searching for a component that is relevant to the service keyword and the user condition; searching for a resource needed to operate the searched for component; analyzing whether the searched for component and the searched for resource are usable according to the user condition; when the searched for component and the searched for resource are usable, mapping the searched for component and the searched for resource, inducing a usable service having a relationship with the mapped component and resource, and mapping the usable service to the mapped component and resource; and providing the mapped service and component to a user.

The service keyword may be a word representing a service, and the user condition may be a user requirement condition or a user preference on a provision service.

The searching for the component and the searching for the resource may preferentially search for a relevant component included in a Giga media service platform, when the relevant component included in the Giga media service platform is not found, search for an external component by connecting to another Giga media service apparatus connected to the outside, and when the external component is found, include external reference information in information mapping a component, a resource, and a service that have a relationship with each other to execute the service though the external reference information.

The providing of the mapped component and resource to the user may output the mapped service and component through a display screen in the form of a graphic user interface (GUI).

The Giga media service method may further include: receiving a selection input on the provided service and component; determining validity of the selected service and component; when the selected service and component are determined to have validity, registering accessibility of the selected service and component; registering a service procedure controlling a flow of the selected service, and a component procedure of components used according to the service procedure; registering the selected service and component, and allocating a resource used according to the selected component; and executing the selected service according to the service procedure and the component procedure.

The determining of the validity may determine that the validity of the selected service and component is deteriorated when it is difficult to combine the selected service and component, and output a notification message according to the determination result.

The executing of the selected service may include monitoring whether the selected service is normally executed according to the service procedure and the component procedure.

According to another aspect of the present invention, there is provided a Giga media service apparatus.

The Giga media service apparatus includes a user interface input unit; a user interface output unit; a network interface; a memory configured to store a command; and a processor configured to execute the command, wherein the command executes a Giga media service method including receiving a service keyword and a user condition; searching for a component that is relevant to the service keyword and the user condition; searching for a resource needed to operate the searched for component; analyzing whether the searched for component and the searched for resource are usable according to the user condition; when the searched for component and the searched for resource are usable, mapping the searched component and the searched resource, inducing a usable service having a relationship with the mapped component and resource, and mapping the usable service to the mapped component and resource; and providing the mapped service and component to a user.

The service keyword may be a word representing a service, and the user condition may be a user requirement condition or a user preference on a provision service.

The searching for the component and the searching for the resource may preferentially search for a relevant component included in a Giga media service platform, when the relevant component in the Giga media service platform is not found, search for an external component by connecting to another Giga media service apparatus connected to the outside, and when the external component is found, include external reference information in information mapping a component, a resource, and a service that have a relationship with each other to execute the service though the external reference information.

The providing of the mapped component and resource to the user may output the mapped service and component through a display screen in the form of a graphic user interface (GUI).

The Giga media service method may further include receiving a selection input on the provided service and component; determining validity of the selected service and component; when the selected service and component are determined to have the validity, registering accessibility of the selected service and component; registering a service procedure controlling a flow of the selected service, and a component procedure of components used according to the service procedure; registering the selected service and component, and allocating a resource used according to the selected component; and executing the selected service according to the service procedure and the component procedure.

The determining of the validity may determine that the validity of the selected service and component is deteriorated when it is difficult to combine the selected service and component, and output a notification message according to the determination result.

The executing of the selected service may include monitoring whether the selected service is normally executed according to the service procedure and the component procedure.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a flowchart for describing a Giga media service method performed by a Giga media service according to an embodiment of the present invention; and

FIG. 2 is a schematic diagram illustrating a Giga media service apparatus according to an embodiment of the present invention.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications, equivalents, and alternative forms can be made without departing from the spirit and scope of the invention.

Hereinafter, in the following description with respect to embodiments of the present invention, when a detailed description of known functions or configurations related to the present invention unnecessarily obscures the gist of the present invention, a detailed description thereof will be omitted. Numerals (for example, a first, a second, etc.) used in the description of the present invention are merely an identifier for identifying one component with another component.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements. Other words used to describe relationships between elements should be interpreted in a like fashion (i.e., “between” versus “directly between,” “adjacent” versus “directly adjacent,” etc.).

Hereinafter, embodiments of the present inventive concept will be described below with reference to the accompanying drawings. In the following description of the present invention, the same reference numerals are used in the same means regardless of the reference numerals to help a thorough understanding.

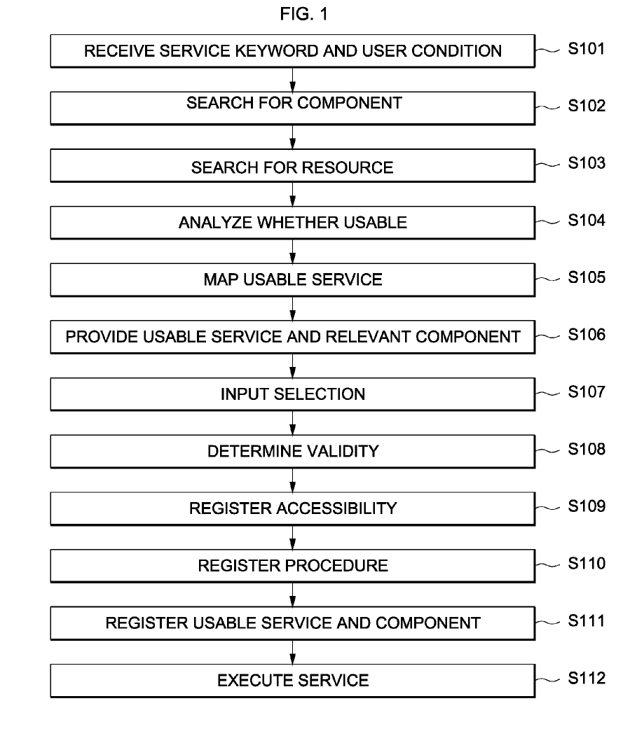

FIG. 1 is a flowchart for describing a Giga media service method performed by a Giga media service according to an embodiment of the present invention. The Giga media service apparatus may perform a method of finding a usable component and resource based on a user condition and a keyword in order to perform a service automatic configuration for providing the Giga media service, mapping a relationship, registering accessibility and a procedure according to a method of providing a usable service to a user and a user's selection, registering the usable service, resource, and component, and executing a service.

In the present invention, a Giga media may include a media having a Giga capacity, for example, multiple full high definition (HD) media, ultra-HD (UHD) media, super-multiview media, and hologram media. The Giga media service may include user unified management, user service management, user authentication management, a one-on-one video chatting service, a multilateral face-to-face collaboration service, a three-way video conference service, a user emotion service, a media sharing service, a room management service, a one-on-one chatting service, an announcement and notification service, an emotion information provision service, a document sharing service, a content search service, a white board service, a multi view collaboration service, a platform operating portal service, device connection and status management, bulletin management, a realistic information reproduction service, scheduling, a learning service, learning assessment management, a real-time medical consultation service, data input management, a vaccination service, a remote medical examination service, etc.

In operation S101, the Giga media service apparatus may receive the service keyword and the user condition from a provider or a user of a Giga media service. For example, the service keyword may be a word representing a service such as video telephony, data sharing, chatting, etc., and the user condition may be a user requirement condition or a user preference on a provision service such as HD, full HD, one-on-one, multilateral, etc.

In operation S102, the Giga media service apparatus may search for a component which is relevant to the service keyword and the user condition using the received service keyword and user condition. For example, the Giga media service apparatus may preferentially search for the relevant component included in a Giga media service platform. When one or more relevant components for a service are not found in the Giga media service platform, the Giga media service apparatus may search for an external component by connecting to another Giga media service apparatus (or a server) connected to the outside.

When the external component is found, the Giga media service apparatus may include external reference information in information mapping the component, the resource, and the service, which are relevant to each other, so that the service is executed through the external reference information such as a uniform resource locator (URL).

In operation S103, the Giga media service apparatus may search for the relevant resource needed to operate the searched for component. For example, the Giga media service apparatus may preferentially search for the relevant resource included in the Giga media service platform, and when the relevant resource is not found in the Giga media service platform, search for and utilize the external resource like the external component in the operation S102.

For example, when the provision service is the video chatting service, the relevant component may be log-in, video sharing, voice sharing, chatting message sharing, etc., for generating a room and integrating rooms, and the relevant resource may be a memory resource included in the Giga media service apparatus for generating the room, a hardware encoder for mixing multilateral videos, a network storage for data sharing, etc.

In operation S104, the Giga media service apparatus may analyze whether the searched for relevant component and relevant resource are usable according to the user condition.

For example, since the searched for relevant resource is partially used in another service, more support may be difficult. That is, supposing that the hardware encoder receives and mixes 8 HD images, the hardware encoder may not process a ninth image. In order to analyze this case, the Giga media service apparatus may confirm the user requirement condition or the user preference, and analyze whether the searched for resource is usable. That is, supposing that the searched for resource is the hardware encoder which may mix 8 HD images and 4 full HD images, and the user requirement condition or the user preference is the full HD, the Giga media service apparatus may determine the found hardware encoder as the usable resource since the found hardware encoder is able to process 4 full HD images, and also, the searched for component may be determined as the usable resource.

In operation S105, the Giga media service apparatus may map the usable component and the usable resource that have a relationship, induce a usable service having the relationship through the mapping, and map the usable service to the usable component and the usable resource that are mapped.

For example, supposing that the usable resource is a Giga network and the hardware encoder, and the usable component is the login, the video sharing, the voice sharing, the chatting message sharing, etc., the hardware encoder may have the relationship with the video sharing and the voice sharing, and the chatting message sharing may have the relationship with the Giga network. Based on this, various services such as the one-on-one video telephony service, the multilateral video conference service, the one-on-one chatting service, the multilateral chatting service, the document sharing service, and the media sharing service may be induced.

In operation S106, the Giga media service apparatus may provide the usable service and the relevant component that are mapped to the user. For example, the Giga media service apparatus may output the usable service and the relevant component in the form of a graphic user interface (GUI) through a display screen.

In operation S107, the Giga media service apparatus may receive a selection input from the provider or the user of the media service on the usable service and the relevant component that are provided. For example, the provider or the user of the media service may make a selection by simply checking a desired service and a component which is relevant to the service on the GUI.

In operation S108, the Giga media service apparatus may determine validity of the service and the component selected by the user. For example, the Giga media service apparatus may determine that the validity of the service and the component selected by the user is deteriorated when it is difficult to combine the service and the component selected by the user, output a notification message according to the determination result, and provide it to the user.

In operation S109, the Giga media service apparatus may register accessibility of the service and the component selected by the user. For example, when the service selected by the user is the login service and the one-on-one video telephony, the service accessibility may be set so that the video telephony for one person authenticated through the login service is possible, and the component accessibility may be set so that the login management component and the voice sharing for the one-on-one video telephony are accessible.

In operation S110, the Giga media service apparatus may register a service procedure controlling a flow of a service, and a procedure of components used according to the service procedure.

For example, in the one-on-one video telephony, the service procedure may allow the user starting the service to log in to the service, and generate a one-on-one video telephony room or obtain a list of users which are previously logged in. Further, when user information which are previously logged in and a user who desires to do the video telephony exist, the service procedure may try to do the video telephony, and transmit an alarm message for the video telephony to a counterpart user of the videotelephony through a signal processing that the user does not recognize, and when the counterpart user of the video telephony accepts, start the one-on-on video telephony. Moreover, when ending the video telephony, the service procedure may release the component and the resource used after ending the one-on-one video telephony. Similarly, the component procedure may register a procedure of the components used according to the service procedure.

In operation S111, the Giga media service apparatus may finally register the usable service and component, and allocate the resource used according to the component. Accordingly, the Giga media service apparatus may complete a preparation capable of starting the service.

In operation S112, the Giga media service apparatus may execute the service according to the service procedure and the component procedure. In this case, the Giga media service apparatus may monitor whether the service is normally operated according to the service procedure and the component procedure.

For example, the Giga media service apparatus may transmit the alarm message capable of notifying the user according to the procedure to the user while the service is executed. The Giga media service apparatus may process a normal message and an error message, etc. while the service is executed, and reference a relationship mapping for another service using real-time change information of the component and the resource.

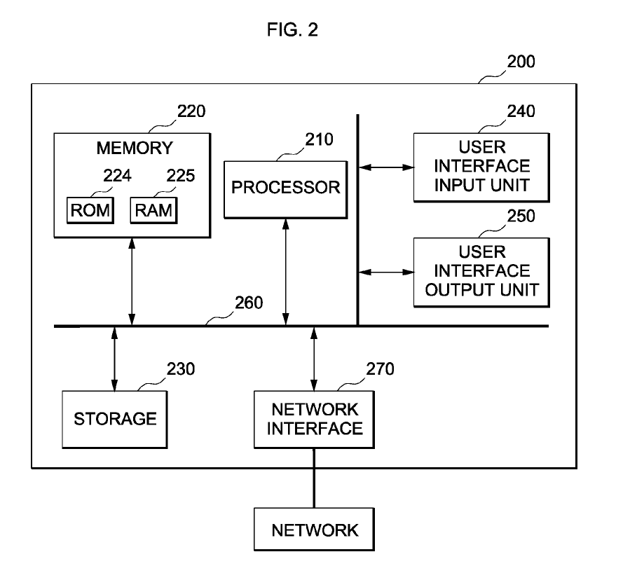

The Giga media service method according to an embodiment of the present invention may be recorded in a computer readable recording medium by being implemented in the form of a program instruction that is executable through a means of electronically processing a variety of information. For example, FIG. 2 is a schematic diagram illustrating a Giga media service apparatus according to an embodiment of the present invention. As shown in FIG. 2, the Giga media service apparatus 200 may include one or more elements among one or more processors 210, a memory 220, a storage unit 230, a user interface input unit 240, and a user interface output unit 250, and the elements may communicate with each other through a bus 260. Further, the Giga media service apparatus 200 may also include a network interface 270 for connecting to a network. The processor 210 may be a central processing unit (CPU) or a semiconductor device for executing a processing instruction stored in the memory 220 and/or the storage unit 230. The memory 220 and the storage unit 230 may include various kinds of volatile or non-volatile storage media. For example, the memory 220 may include a read-only memory (ROM) 224, and a random access memory (RAM) 225.

Accordingly, the Giga media service method according to an embodiment of the present invention may be implemented by a non-volatile computer recording medium in which a method implemented by a computer or computer-executable instructions are stored. The instructions may perform the method according to at least one of the embodiments of the present invention when being executed by the processor.

According to the present invention, the provider or the user of the service can search for the component and the resource on the service using the keyword and the condition, automatically configure the component and the resource by selecting by the relationship, and register and provide the new service.

The present invention is described based on the above-described exemplary embodiments. It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A Giga media service method performed by a Giga media service apparatus, comprising:
receiving a service keyword and a user condition;
searching for a component that is relevant to the service keyword and the user condition;
searching for a resource needed to operate the searched for component;
analyzing whether the searched for component and the searched for resource are usable according to the user condition;
when the searched for component and the searched for resource are usable, mapping the searched for component and the searched for resource, inducing a usable service having a relationship with the mapped component and resource, and mapping the usable service to the mapped component and resource; and
providing the mapped service and component to a user.

2. The Giga media service method of claim 1, wherein the service keyword is a word representing a service, and the user condition is a user requirement condition or a user preference on a provision service.

3. The Giga media service method of claim 1, wherein the searching for the component and the searching for the resource preferentially searches for a relevant component included in a Giga media service platform, when the relevant component included in the Giga media service platform is not found, searches for an external component by connecting to another Giga media service apparatus connected to the outside, and when the external component is found, includes external reference information in information mapping a component, a resource, and a service that have a relationship with each other to execute the service though the external reference information.

4. The Giga media service method of claim 1, wherein the providing of the mapped component and resource to the user outputs the mapped service and component through a display screen in the form of a graphic user interface (GUI).

5. The Giga media service method of claim 1, further comprising:
receiving a selection input on the provided service and component;
determining validity of the selected service and component;
when the selected service and component are determined to have validity, registering accessibility of the selected service and component;
registering a service procedure controlling a flow of the selected service, and a component procedure of components used according to the service procedure;
registering the selected service and component, and allocating a resource used according to the selected component; and
executing the selected service according to the service procedure and the component procedure.

6. The Giga media service method of claim 5, wherein the determining of the validity determines that the validity of the selected service and component is deteriorated when it is difficult to combine the selected service and component, and outputs a notification message according to the determination result.

7. The Giga media service method of claim 5, wherein the executing of the selected service comprises monitoring whether the selected service is normally executed according to the service procedure and the component procedure.

8. A Giga media service apparatus, comprising:
a user interface input unit;
a user interface output unit;
a network interface;
a memory configured to store a command; and
a processor configured to execute the command,
wherein the command executes a Giga media service method comprising:
receiving a service keyword and a user condition;
searching for a component that is relevant to the service keyword and the user condition;
searching for a resource needed to operate the searched for component;
analyzing whether the searched for component and the searched for resource are usable according to the user condition;
when the searched for component and the searched for resource are usable, mapping the searched for component and the searched for resource, inducing a usable service having a relationship with the mapped component and resource, and mapping the usable service to the mapped component and resource; and
providing the mapped service and component to a user.

9. The Giga media service apparatus of claim 8, wherein the service keyword is a word representing a service, and the user condition is a user requirement condition or a user preference on a provision service.

10. The Giga media service apparatus of claim 8, wherein the searching for the component and the searching for the resource preferentially searches for a relevant component included in a Giga media service platform, when the relevant component in the Giga media service platform is not found, searches for an external component by connecting to another Giga media service apparatus connected to the outside, and when the external component is found, includes external reference information in information mapping a component, a resource, and a service that have a relationship with each other to execute the service though the external reference information.

11. The Giga media service apparatus of claim 8, wherein the providing of the mapped component and resource to the user outputs the mapped service and component through a display screen in the form of a graphic user interface (GUI).

12. The Giga media service apparatus of claim 8, wherein the Giga media service method further comprises:
receiving a selection input on the provided service and component;
determining validity of the selected service and component;
when the selected service and component are determined to have validity, registering accessibility of the selected service and component;
registering a service procedure controlling a flow of the selected service, and a component procedure of components used according to the service procedure;
registering the selected service and component, and allocating a resource used according to the selected component; and
executing the selected service according to the service procedure and the component procedure.

13. The Giga media service apparatus of claim 12, wherein the determining of the validity determines that the validity of the selected service and component is deteriorated when it is difficult to combine the selected service and component, and outputs a notification message according to the determination result.

14. The Giga media service apparatus of claim 12, wherein the executing of the selected service comprises monitoring whether the selected service is normally executed according to the service procedure and the component procedure.
